(19) United States
(12) Patent Application Publication
(10) Pub. No.: US 2021/0099590 A1
(43) Pub. Date: Apr. 1, 2021

(54) SYSTEM AND METHOD FOR UNIFORM SOFTWARE DEPLOYMENT TO DEVICES WITH DIFFERENT CONFIGURATIONS

(71) Applicant: Toshiba TEC Kabushiki Kaisha, Shinagawa-ku (JP)

(72) Inventors: Jia ZHANG, Irvine, CA (US); Christopher NGUYEN, Huntington Beach, CA (US)

(21) Appl. No.: 16/583,764

(22) Filed: Sep. 26, 2019

(51) Int. Cl. H04N 1/00; H04L 12/24; G06F 8/60

(52) U.S. Cl. CPC H04N 1/00503; H04N 1/00973; G06F 8/60; H04N 1/00408; H04L 41/0806; H04N 1/00949

(57) ABSTRACT

A system and method for deploying software such as a distributed customized user interface package creates a single package for deploying the interface to multifunction peripherals having different characteristics. A customized user interface is associated with each of a plurality of base binary files which correspond to different multifunction peripheral characteristics, such as firmware version or touchscreen size. A user interface configuration module is created for each binary file. The user interface configuration modules are described with associated metadata. All user interface configuration modules are packaged and deployed to an application deployment tool. The application deployment tool identifies networked multifunction peripherals and their individual characteristics to deploy a compatible user interface configuration module for installation.

### TECHNICAL FIELD

This application relates generally to reconfiguring multiple devices having different characteristics via a network connection. The application relates more particularly to distributing a new user interface configuration to multiple multifunction peripherals, with each user interface configuration being tailored to specific properties of a targeted device, such as its firmware version or its touchscreen size.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

Multifunction peripherals are complex devices that may be periodically configured or reconfigured. Certain reconfigurations can be difficult or problematic, such as configurations that are dependent on individual device characteristics of many MFPs that are in concurrent use by a business. Such reconfigurations may require dispatching a technician to a premises wherein they manually reconfigure each MFP, one at a time.

### BRIEF DESCRIPTION OF THE DRAWINGS

Various embodiments will become better understood with regard to the following description, appended claims and accompanying drawings wherein:

FIG. 1 is an example embodiment of a system for reconfiguring multiple devices having different characteristics via a networked device installation;

FIG. 2 is an example embodiment of a digital device such a multifunction peripheral;

FIG. 3 is an example embodiment of a digital device system such as a computer;

FIG. 4 is a flow diagram of an example embodiment of a system for formation and distribution of user interface configurations via a single package and an application deployment tool;

FIG. 5 is an example embodiment of an application deployment tool;

FIG. 6 is a flowchart of an example embodiment of a system for creating a single package for deployment; and

FIG. 7 is an example embodiment of operations of an application deployment tool.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, MFPs must be configured or reconfigured on a periodic basis. Reconfiguration may include changing device settings, adding or updating software, including software applications, or reconfiguring a device user interface. Rather than deploying a technician to each device, reconfiguration may be accomplished by use of an application deployment tool running on a networked computer, which application deployment tool allows MFPs to be reconfigured via a network connection.

In a particular example, a business develops a custom MFP user interface that it wants to distribute and install to all of its devices, providing a uniform, custom user interface across the business. User interfaces are created by software, such as software to generate images and receive input on an MFP. There may be situations where various MFPs have different configurations, making rollout of a custom interface difficult. For example, different MFPs may have different firmware versions or different touchscreen sizes. There may also be relationships between firmware versions and touchscreen sizes. Due to such restrictions, when an MFP with new screen size and/or a new version of firmware is released, user interface configuration must be updated accordingly.

The subject application includes example embodiments wherein a single installation package can be deployed which accommodates configuration of MFPs with differing configurations. An application deployment tool automatically determines a correct configuration, such as a user interface configuration (user interface configuration), for a single package deployment for intelligent reconfiguration of multiple MFPs based on individual device configurations, such as firmware versions or touchscreen sizes.

In a particular example embodiment, an administrator uploads all user interface configuration base binaries, such as those that support different MFP screen sizes or different firmware versions, into one repository. An export configuration function suitably referred to as a single package creation module, stores all user interface configuration base binaries associated with MFPs and creates one user interface configuration for each user interface configuration base binary based on selected configuration settings. The creating module then compiles a metadata file to describe each user interface configuration, which metadata file describes a supported screen size, group of supporting firmware, hash value, version information, and the like. The single package is deployed to an application deployment tool device, including correlated metadata files and user interface configuration binaries.

Once the application deployment tool receives a single package, it reads the metadata file for validation. Then a discovery process is initiated at the application deployment tool device and it retrieves each target MFP's screen size and firmware version by sending an SNMP query. The application deployment tool selects all user interface configurations which support the target MFP's screen size from single package first, then it checks each user interface configuration support firmware version. The application deployment tool selects the matching user interface configuration binary using the logic validation of the lowest firmware difference against the available MFP's firmware version. Thus, the system creates one single package with multiple user interface configurations which support different MFP screen sizes and different firmware.

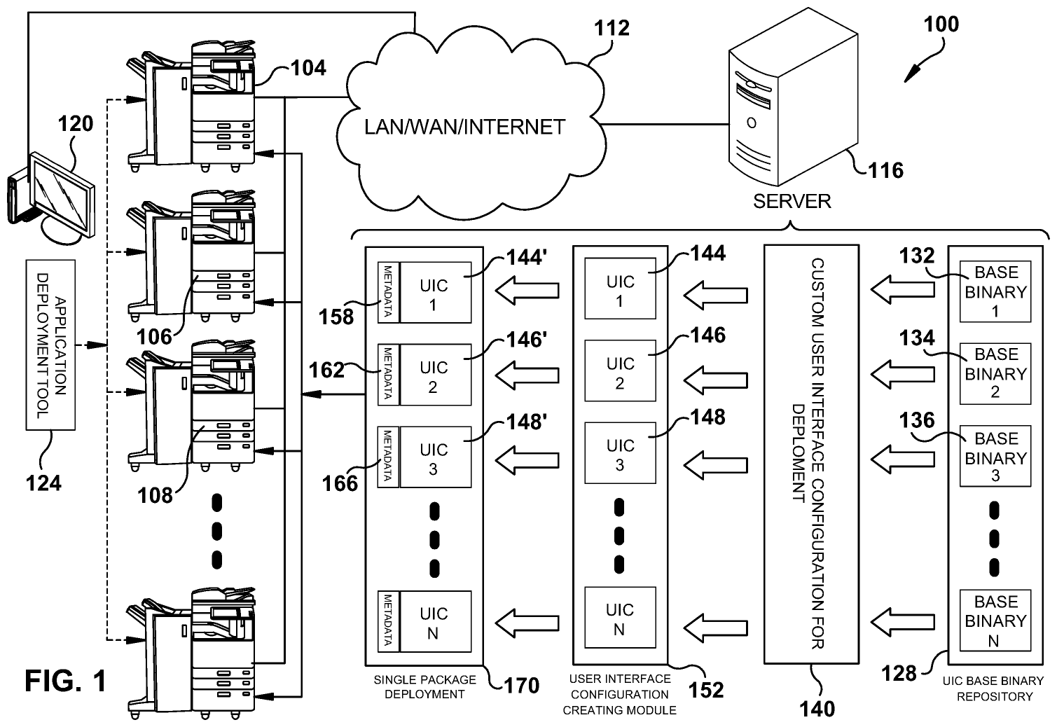

In accordance with the subject application, FIG. 1 illustrates an example embodiment of a system 100 for reconfiguring multiple devices having different characteristics via a networked device installation. Multiple MFPs, such as MFPs 104, 106 and 108 are in data communication with network cloud 112, suitably comprised of a local area network (LAN), a wide area network (WAN), which may comprise the Internet, or any suitable combination thereof. Also in data communication with network cloud 112 is server 116 and an administrative computer 120. Administrative computer 120 includes an application deployment tool 124 which detects MFPs on the network, obtains information from the MFPs and installs software, including applications or configurations, including user interface configurations to the MFPs.

Server 116 includes storage for a user interface configuration base binary repository 128, comprised of a plurality of device base binaries, such as base binaries 132, 134 and 136. Different base binaries support different MFP characteristics, such as screen sizes or firmware versions. Each base binary is associated with a customized configuration 140, such as a customized user interface to be distributed to multiple MFPs. This association generates a plurality of user interface configuration modules, such as modules 144, 146 and 148, with each module adapted for installation on an MFP compatible with its associated base binary. Such association is accomplished via user interface creating module 152. Each user interface configuration module is associated with metadata that describes it, such as describing its associated screen size or firmware version. In the illustrated example, user interface configuration 144′ is associated with metadata 158, user interface configuration 146′ is associated with metadata 162 and user interface configuration 148′ is associated with metadata 166. All user interface configurations and their associated metadata form a single package 170 for deployment to MFPs via application development tool 124 running on administrative computer 120.

As will be detailed further below, application development tool 124 identifies networked MFPs and determines characteristics or configurations of identified MFPs, such as firmware version and touchscreen size. Such determination is suitably accomplished by an SNMP query to each identified MFP. Application development tool 124 matches each MFP's configuration information with metadata of the user interface modules and determines which is compatible for each MFP targeted for configuration. The appropriate user interface module is then sent to each targeted MFP for installation.

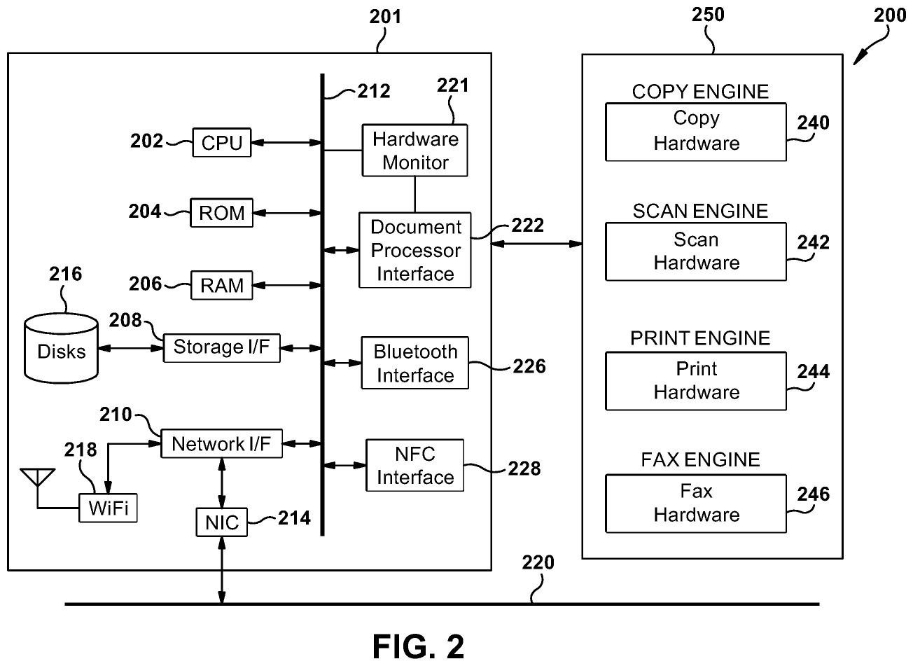

Turning now to FIG. 2 illustrated is an example embodiment of a networked digital device comprised of document rendering system 200 suitably comprised within an MFP, such as with MFPs 104, 106 and 108 of FIG. 1. It will be appreciated that an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication a document processor interface 222, with BLUETOOTH interface 226 and NFC interface 228 via data path 212.

Processor 202 can also be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrate example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

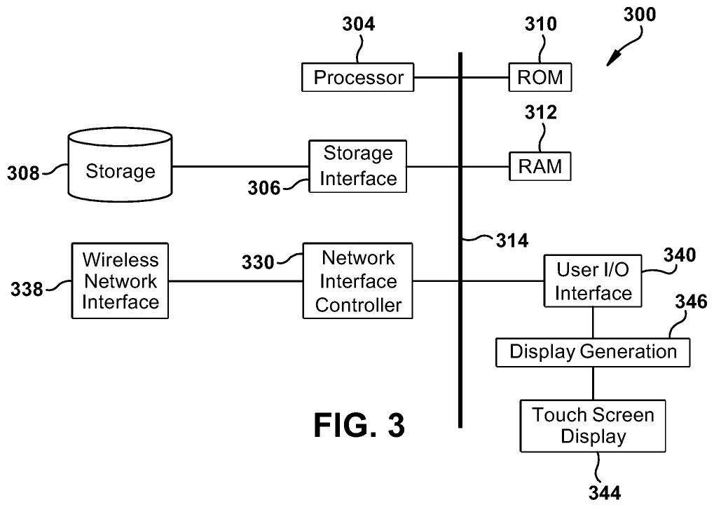

Turning now to FIG. 3, illustrated is an example of a digital device system 300 suitably comprising server 116 and administrative computer 120 of FIG. 1. Included are one or more processors, such as that illustrated by processor 304. Each processor is suitably associated with non-volatile memory, such as read only memory (ROM) 310 and random access memory (RAM) 312, via a data bus 314.

Processor 304 is also in data communication with a storage interface 306 for reading or writing to a data storage system 308, suitably comprised of a hard disk, optical disk, solid-state disk, or any other suitable data storage as will be appreciated by one of ordinary skill in the art.

Processor 304 is also in data communication with a network interface controller (NIC) 330, which provides a data path to any suitable network or device connection, such as a suitable wireless data connection via wireless network interface 338. A suitable data connection to an MFP or server is via a data network, such as a local area network (LAN), a wide arear network (WAN), which may comprise the Internet, or any suitable combination thereof. A digital data connection is also suitably directly with an MFP or server, such as via BLUETOOTH, optical data transfer, Wi-Fi direct, or the like.

Processor 304 is also in data communication with a user input/output (I/O) interface 340 which provides data communication with user peripherals, such as touch screen display 344 via display generator 346, as well as keyboards, mice, track balls, touch screens, or the like. It will be understood that functional units are suitably comprised of intelligent units, including any suitable hardware or software platform.

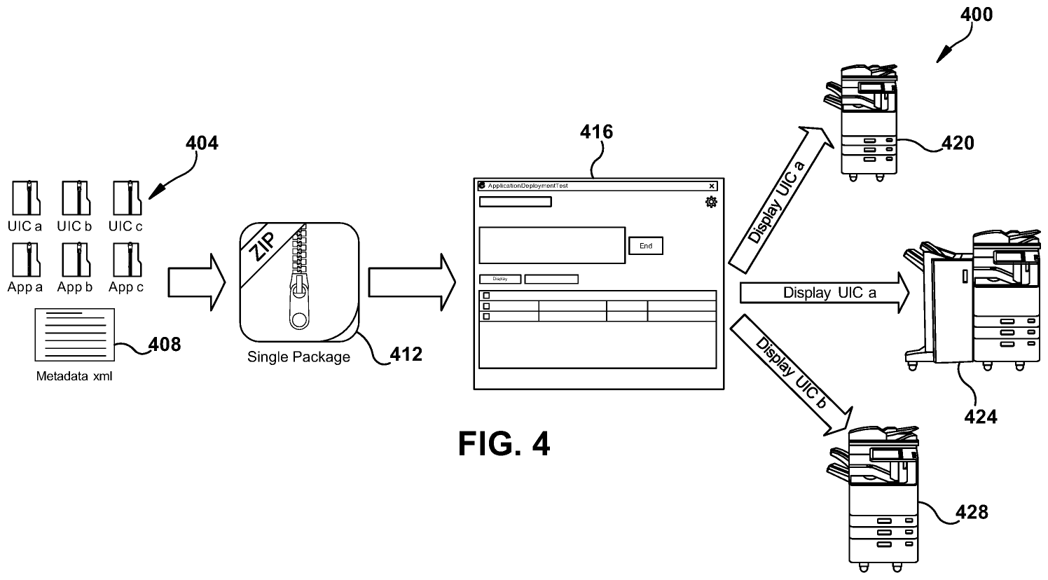

FIG. 4 is a flow diagram 400 of an example embodiment for formation and distribution of user interface configurations via a single package and an application deployment tool. A set of user interface configuration files 404 are conjoined with metadata 408 into a single package 412 for deployment. In the example, all user interface configurations and metadata are contained in a single package formed as a compressed or zipped file. Single package 412 is deployed to application deployment tool 416 which determines which user interface configuration is appropriate for MFPs 420, 424 and 428. Application deployment tool 416 sends the appropriate user interface configuration to each MFP.

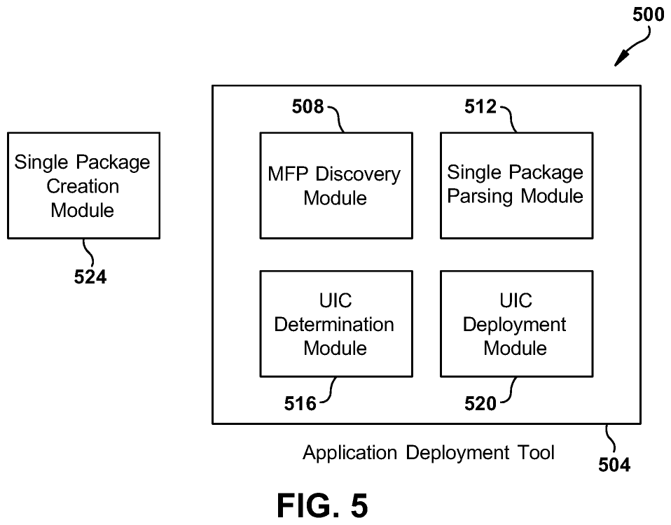

FIG. 5 illustrates an example embodiment of an application deployment tool module 500. Included is a user interface configuration creation module 504 that includes MFP discovery module 508, single package parsing module 512, user interface configuration determination module 516 and user interface deployment module 520. A single package creation module 524 creates a single package for distribution in accordance with user interface configurations and associated metadata created by configuration creation module 504.

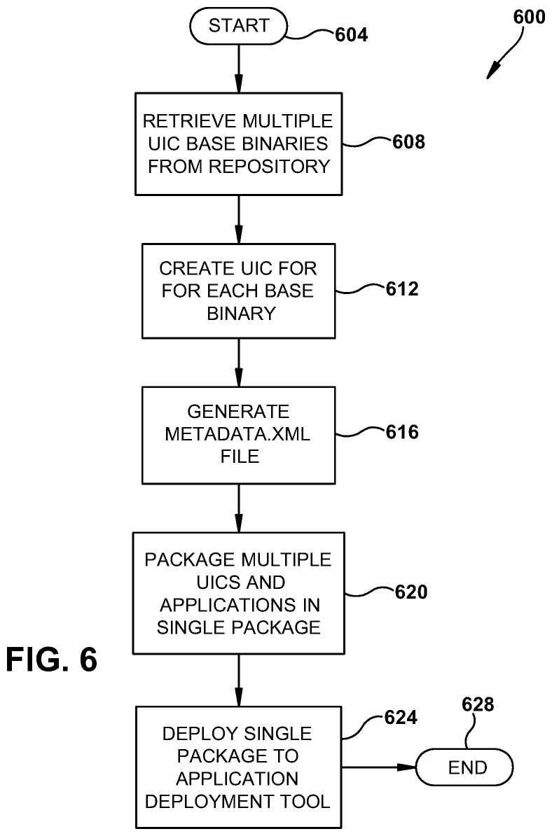

FIG. 6 is a flowchart 600 of an example embodiment a system for creating a single package for deployment. The system starts at block 604 and proceeds to block 608 where multiple user interface configuration base binaries are retrieved. Next, a user interface configuration is created for each base binary in accordance with a desired user interface for distribution and installation at block 612. Descriptive metadata is generated at block 616, and all user interfaces configurations and associated metadata forms a single package at block 620. The single package is sent to an application deployment tool at block 624 and the process suitably ends at block 628.

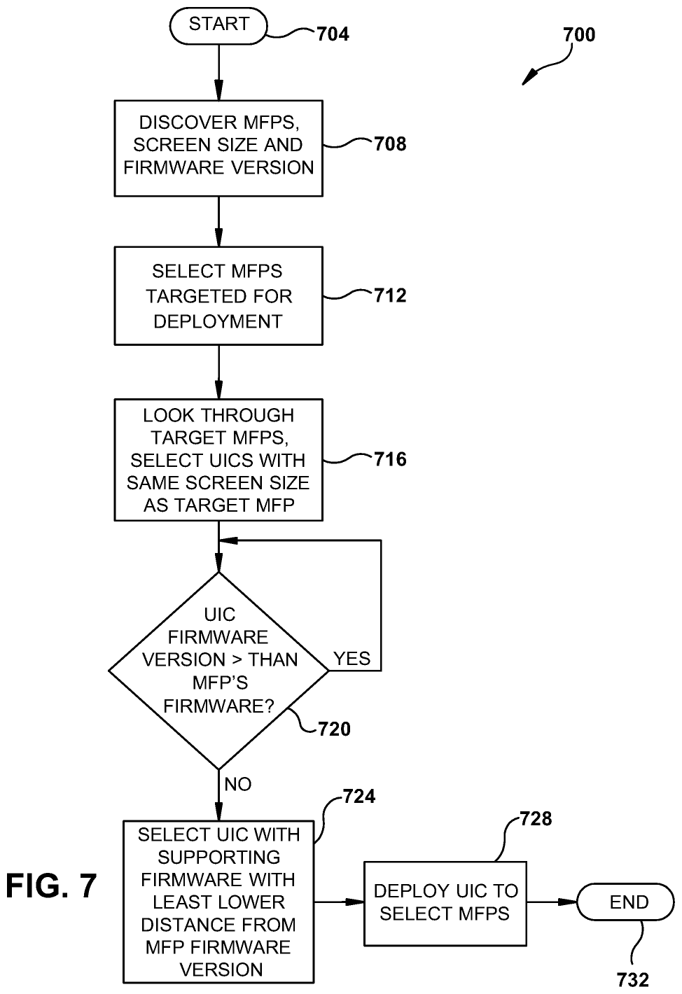

FIG. 7 is a flowchart 700 of an example embodiment of an operation of an application deployment tool. The process commences at block 704 and proceeds to block 708 where networked MFPs are discovered, along with their corresponding screen size and firmware version. MFPs targeted for deployment are identified in block 712. A match is sought at block 716 between target MFPs and user interface configurations that have a matching screen size as determined from their associated metadata. Next, a sequential check of matching user interface configurations is made at block 720. If a user interface configuration has a firmware version greater than that of an MFP, a next user interface configuration is checked as the process returns to block 720. Once a user interface version firmware version is equal to or less than that of the MFP, the process proceeds to block 724 where a user interface configuration closest to that of the version of the MFP is selected, and this user interface configuration is deployed at block 728. The process suitably ends at block 732.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

1. A system comprising:
a processor;
a network interface; and
a memory storing base binary configuration files, each base binary configuration file associated with a specified multifunction peripheral screen size and firmware configuration, the memory further storing a customized user interface configuration file corresponding to a customized multifunction peripheral user interface for installation on one or more multifunction peripherals,
wherein the processor is configured to generate a unique device user interface configuration file for each base binary configuration file in accordance with the custom user interface configuration file,
wherein the processor is further configured to generate metadata associated with and descriptive of each base binary configuration file,
wherein the processor is further configured to generate a single deployment package including each device user interface configuration file and associated metadata,
wherein the processor is further configured to communicate the single deployment package for configuration of each of a plurality of multifunction peripherals via the network interface, and
wherein each of the plurality of multifunction peripherals is configured to
determine its screen size and firmware version,
receive the single deployment package,
determine which binary configuration files in the single deployment package are compatible with a determined screen size and firmware version in accordance with metadata in the single deployment package,
select a compatible binary configuration file in accordance with a comparison of its associated firmware version and a determined firmware version, and
install a user interface associated with a selected binary configuration file.

2. (canceled)

3. (canceled)

4. (canceled)

5. (canceled)

6. (canceled)

7. (canceled)

8. A method comprising:
storing, in a memory, base binary configuration files, each base binary configuration file associated with a specified multifunction peripheral screen size and firmware configuration;
storing, in the memory, a customized user interface configuration file corresponding to a customized multifunction peripheral user interface for installation on one or more multifunction peripherals;
generating a unique device user interface configuration file for each base binary configuration file in accordance with the custom user interface configuration file;
generating metadata associated with and descriptive of each base binary configuration file;
generating a single deployment package including each device user interface configuration file;
communicating the single deployment package for configuration of each of a plurality of multifunction peripherals via a network interface install a user interface associated with a selected binary configuration file; and
for each multifunction peripheral
determining its screen size and firmware version,
receiving the single deployment package,
determining which binary configuration files in the single deployment package are compatible with a determined screen size and firmware version in accordance with metadata in the single deployment package,
selecting a compatible binary configuration file in accordance with a comparison of its associated firmware version and a determined firmware version, and
installing a user interface associated with a selected binary configuration file.

9. (canceled)

10. (canceled)

11. (canceled)

12. (canceled)

13. (canceled)

14. (canceled)

15. A multifunction peripheral comprising:
a processor;
memory; and
a network interface,
wherein the processor is configured to identify a multifunction peripheral configuration comprising a screen size and firmware version of each of the multifunction peripheral;
wherein the memory is configured to store a single deployment single deployment package including
a plurality of device user interface configuration files, each device user interface configuration file associated with a unique screen size and firmware version, each configuration file including
a customized device user interface configuration generated with a base binary configuration file associated with a unique multifunction peripheral configuration, and
metadata descriptive of its unique multifunction peripheral configuration,
wherein the processor is further configured select a device user interface configuration file for the networked multifunction peripheral in accordance with its identified configuration and device configuration file metadata, and
wherein the processor is further configured to install a selected device user interface configuration on the multifunction peripheral.

16. (canceled)

17. (canceled)

18. The multifunction peripheral of claim 15 wherein the single deployment package further includes one or more multifunction peripheral applications, and
wherein the processor is further configured to communicate the one or more multifunction peripheral applications to the associated multifunction peripheral via the network interface.

19. The multifunction peripheral of claim 18 wherein the processor is further configured to identify the multifunction peripheral configuration in accordance with an SNMP query.

20. The multifunction peripheral of claim 15 wherein the processor is further configured to select a device the device configuration file for each networked multifunction peripheral by a sequential check of metadata of each device user interface configuration file with a corresponding multifunction peripheral configuration until a match is found.

21. The system of claim 1 wherein the processor is further configured to select the compatible binary configuration file having a firmware version closest to a determined firmware version.

22. The method of claim 15 wherein the processor is further configured to select the compatible binary configuration file having a firmware version closest to a determined firmware version.
